(19) United States
(12) Patent Application Publication
(10) Pub. No.: US 2005/0057519 A1
(43) Pub. Date: Mar. 17, 2005

(54) Control board system to indicate hardware events

(76) Inventors: Christopher D. Coe, Hillsboro, OR (US); Kerry B. Vander Kamp, Hillsboro, OR (US)

Correspondence Address: INTEL CORPORATION, P.O. BOX 5326, SANTA CLARA, CA, 95056-5326, US

(21) Appl. No.: 10/812,652

(22) Filed: Mar. 29, 2004

Related U.S. Application Data
(60) Provisional application No. 60/502,426, filed on Sep. 12, 2003.

(51) Int. Cl. G06F 13/12; G06F 13/38; G09G 5/00

(52) U.S. Cl. 345/168

(57) ABSTRACT

Briefly, in accordance with one embodiment of the invention, a control board system may include a control panel to control a computing platform using a human interface device manager to indicate and to control hardware events on the computing platform. The hardware events may be received by general purpose input/output circuit.

### CROSS-REFERENCE TO RELATED APPLICATION

The present application claims the benefit of U.S. Provisional Application Ser. No. 60/502,426 filed Sep. 12, 2003.

### BACKGROUND OF THE INVENTION

The general purpose personal computing platform is increasingly being adapted to new usage models, for example as the control center of a home entertainment system to provide audio and video functions such as television. Such general purpose computing platforms have traditionally relied on a standard keyboard and mouse for user input, and on a full size monitor for displaying information. However, such full sized keyboard, mice, and monitors generally do not lend themselves as optimal control devices in the new usage models.

### DESCRIPTION OF THE DRAWING FIGURE

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing in which:

FIG. 1 is a block diagram of a control board system for a general purpose computing platform in accordance with at least one embodiment of the invention.

FIG. 2 is a flow diagram of operation of a control board system of a computing platform in accordance with an embodiment of the present invention;

FIG. 3 is an illustration of a computing platform in accordance with an embodiment of the invention;

FIG. 4 is a top plan view of a computing platform having an input panel in accordance with an embodiment of the invention; and

FIG. 5 is a driver state machine diagram in accordance with one embodiment of the invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as processing, computing, calculating, determining, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

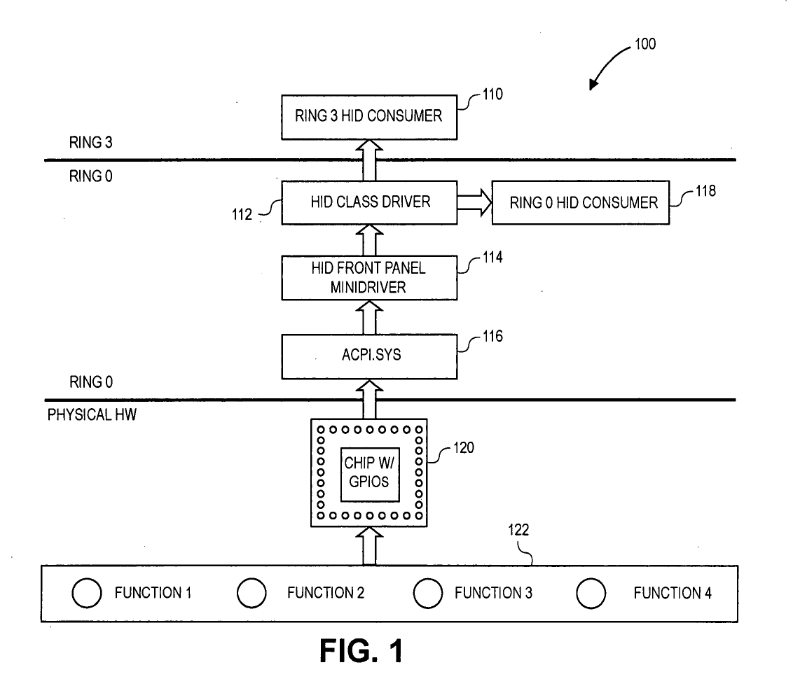

Referring now to FIG. 1, a block diagram of a control board system for a general purpose computing platform in accordance with at least one embodiment of the invention. The control board system 100 of FIG. 1 may include a control panel 122 to provide inputs to control a computing platform in which control board system 100 may be utilized. In one embodiment of the invention, control panel 122 may be disposed on a chassis of the computing platform and may also include output indicators such as light emitting diodes (LED), a liquid crystal display (LCD), an organic light emitting diode (OLED) display, a polymeric display, and so on, for example to indicate the status of control board system, the computing platform, or one or more peripheral devices attached to the computing platform, although the scope of the invention is not limited in this respect.

Control panel 122 may couple to a general purpose input/output (GPIO) circuit 120 to control the input and output functions of control panel 122. GPIO circuit 120 may couple to an advanced configuration power interface (ACPI) 116 (ACPI.SYS) of an operating system (OS) running on the computing platform, which in turn may couple to a human interface device (HID) front panel minidriver 114 (HIDFP minidriver) for control panel 122. ACPI 116 may read and clear I/Os from GPIO 120, and HIDFP minidriver 114 may monitor the status of the GPIO 120 and control panel 122 using ACPI control methods. When a GPIO is triggered by user interaction with control panel 122, HID minidriver 114 may call ACPI control methods to detect changes in hardware status. A change in hardware status may cause an HID report to be generated, which in turn may cause an appropriate action or response visible by the user to occur on the computing platform, for example a change in an indicator on control panel 122 or a response on a display coupled to the computing platform, although the scope of the invention is not limited in this respect. HIDFP minidriver 114 may communicate with HID class driver 112 which in turn may couple with a Ring 0 HID consumer 118 and a Ring 3 HID consumer 110, although the scope of the invention is not limited in this respect.

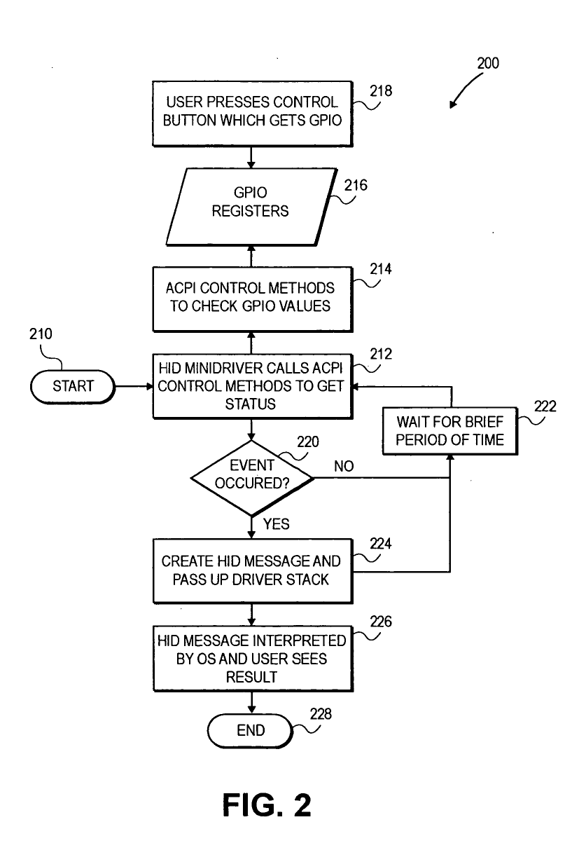

Referring now to FIG. 2, a flow diagram of a method of operation of an electronic device in accordance with an embodiment of the invention will be discussed. As shown in FIG. 2, method 200 may start at block 210 where the HIDFP minidriver 114 may call ACPI 116 control methods at block 212 to obtain a status of control panel 122. At block 214 ACPI 116 control methods check the values of GPIO circuit 120 and read from GPIO registers at block 216. GPIO registers are set for example when a user presses a control button on control panel 122 at block 218. After HIDFP minidriver 114 calls ACPI 116 control methods at block 212 to get the status of the GPIO registers, a determination may be made at block 220 whether an event has occurred on control panel 122. If no event has occurred, HIDFP minidriver 114 may wait for a brief period of time at block 222 before HIDFP minidriver again calls ACPI 116 control methods at block 212 to get the status of the GPIO registers, although the scope of the invention is not limited in this respect.

If an event has occurred as determined at block 220, HIDFP minidriver 114 may create an HID message so indicating and pass an HID message up the driver stack at block 224 to HID class driver 112, Ring 0 HID Consumer 118, and Ring 3 HID consumer 110, which in one embodiment of the invention are the devices doing the interpreting of the HID message, although the scope of the invention is not limited in this respect. The HID message may then be able to be interpreted by the operating system at block 226 which may responding according, for example increasing or decreasing volume, increasing or decreasing brightness, and so on, so that the user may observe the result of the actuation of the corresponding button of control panel 122 that occurred at block 218, although the scope of the invention is not limited in this respect.

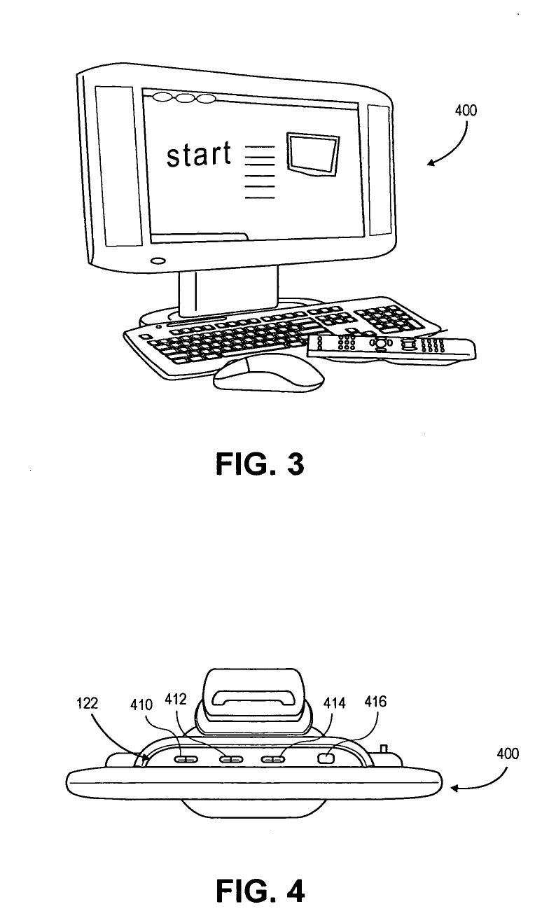

Referring now to FIG. 3, an illustration of a computing platform in accordance with an embodiment of the invention will be discussed. In one embodiment, computing platform 400 may be a Gateway® 610XL Media Center computing platform available from Gateway, Inc. of Poway, Calif. and may include an Intel® Pentium® processor with HT technology available from Intel Corporation of Santa Clara, Calif. to run Microsoft® Windows® XP Media Center Edition 2004 available from Microsoft Corporation of Redmond, Wash., although the scope of the invention is not limited in this respect. The invention may be embodied in other substitutable computing platforms or other electronic devices such as a television, display, music player, and so on, without departing from the scope of the invention.

Referring now to FIG. 4, a top plan view of a computing platform in accordance with one embodiment of the invention will be discussed. Computing platform 400 as shown in FIG. 4 may include control panel 122 having at least one or more control buttons 410, 412, 414, and 416, and so on, to control operating parameters of computing platform 400. For example, control panel 122 of computing platform 400 may include brightness controls 410 to control a brightness setting of a display, tuning controls 412 to select a channel of tuner, volume controls 414 to control a sound output level of an amplifier and speakers, and a power switch 416 to power on and to power off computing platform 400, although the scope of the invention is not limited in this respect.

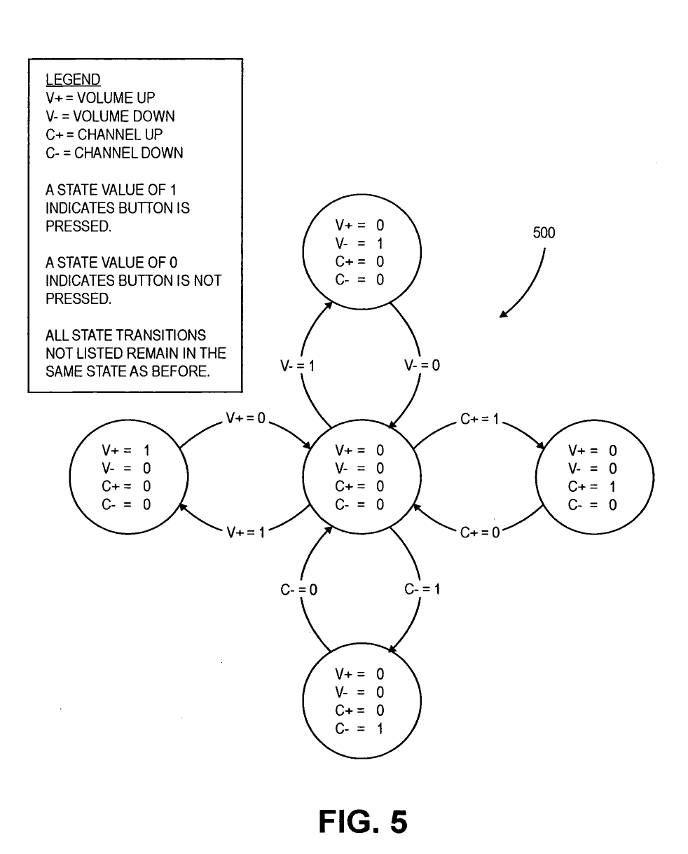

Referring now to FIG. 5, a state machine diagram will be discussed. The state machine diagram 500 shown in FIG. 5 may illustrate at least one mode of operation of control board system 100, although the scope of the invention is not limited in this respect. In at least one embodiment of the invention, the HIDFP minidriver 114 may sit in a stack just below HID class driver 112. Likewise, HIDFP minidriver 114 may sit just above ACPI driver 116 and may communicate with the hardware through ACPI driver 116 by having ACPI driver 116 execute control methods written in authentication and security layer (ASL) code. The basic input/output system (BIOS) of computing platform 400 may be responsible for providing ASL control methods to read and clear the pins of GPIO 120 that indicate actuation of control buttons 410, 412, 414, or 416. The pins of GPIO 120 may be coupled to the control buttons on the control panel 122. When one of control button 410, 412, 414, or 416 is pressed, the Input/Output Controller Hub 5 (ICH5), for example the Intel® 82801EB ICH5, latches the input in the associated pin of GPIO 120. When the HID class driver 112 polls the HIDFP minidriver 114, HIDFP minidriver 114 may check for actuations of control buttons in the hardware of GPIO circuit 120. If an actuation of a control button is detected, the HIDFP minidriver 114 may create an HID report to send up the stack. Any HID consumer applications or drivers that are looking for reports of this type may receive the report, interpret the message, and may perform the appropriate action, although the scope of the invention is not limited in this respect.

In one embodiment of the invention, HIDFP minidriver 114 connects to the HID class driver 112 through a registration process that HID drivers typically perform. Registration allows HID class driver 112 to receive information about the new device as well as support some of the upper level interfaces that HID minidriver 114 may not support. As one part of the registration, HID class driver 112 may be informed whether or not the new device needs to be polled, although the scope of the invention is not limited in this respect.

To connect into ACPI driver 116, the information (“.inf” file extension) file for the HIDFP minidriver 114 may be arranged to indicate the device to which HID minidriver is connected. Once HID minidriver 114 is installed and such a connection is made, HIDFP minidriver 114 may begin requesting the control methods be executed to retrieve data. In one embodiment of the invention, HIDFP minidriver 114 may consist of four main components: Initialization/Shutdown, Windows Driver Model (WDM) IOCTL requirements, HID Class IOCTL requirements, and polling the HID driver.

Initialization of the driver may include arranging entry points in the driver object for the various IOCTL calls the driver receives, registering the driver with the HID class driver, initialization of the device extension, and starting a thread that obtains data from the hardware. The IOCTL calls that are handled by the driver may include:

IRP_MJ_INTERNAL_DEVICE_CONTROL
IRP_MJ_SYSTEM_CONTROL, IRP_MJ_PNP; and
IRP_MJ_POWER.

Other calls may be handled by the driver, and the scope of the invention is not limited in this respect.

The entry points for such calls may be set up on the driver object at initialization. Additionally, entry points may be set up for AddDevice and Unload. When registering with HID class driver 112, HIDFP minidriver 114 may indicate that a request to be polled, which may cause HIDFP driver 114 to be polled at regular intervals.

Initialization of the device extension may set up an initial state of state machine 500 utilized to determine the current state of the various control buttons 410, 412, 414, and 416. Additionally, a synchronization event object may be initialized, which may be signaled when data is ready to be refreshed, and a spin lock may be initialized to prevent data within state machine 500 from being modified by two different routines. The thread that is started during initialization may be utilized to update the data in state machine 500. The thread may utilize control mechanisms in the device extension to ensure atomicity. At shutdown, the driver may ensure that the thread is terminated, although the scope of the invention is not limited in this respect.

In one embodiment of the invention, to fulfill WDM requirements, HIDFP minidriver 114 may provide routines for:

IRP_MJ_INTERNAL_DEVICE_CONTROL;
IRP_MJ_SYSTEM_CONTROL;
IRP_MJ_PNP;
IRP_MJ_POWER;
AddDevice; and
Unload

IRP_MJ_INTERNAL_DEVICE_CONTROL may be utilized for device specific requests. In the case of HIDFP driver 114, HID class driver 112 may define these requests. The IOCTL requests made by HID class driver 112 may be to get a device descriptor, to get attributes of a device, to get a report descriptor of a device, or to read a report from a device. IRP_MJ_SYSTEM_CONTROL may pass the IRP down the device stack. IRP_MJ_PNP may perform Plug and Play processing for the HIDFP minidriver 114. When IRP_MN_REMOVE_DEVICE is received, HIDFP minidriver 114 may signal for the update thread to be terminated, and then wait until it receives notice that it has been terminated. After such an event, the IRP may be passed down the device stack. Various other Plug and Play minor IRPs also may be passed down the device stack.

IRP_MJ_POWER may pass the request down the Power IRP device stack. The main responsibility of the AddDevice routine may be to initialize the various members of the device extension. This may include, for example, variable of state machine 500, the various control and synchronization variables, and starting the thread for getting data. The Unload method may be utilized to do cleanup as needed, although the scope of the invention is not limited in this respect.

The conditions of HID Class IOCTL may be based off calls made on the internal device control IRP by the HID Class driver. The IRPs handled by HID Class driver 112 may include:

IOCTL_HID_GET_DEVICE_DESCRIPTOR
IOCTL_HID_GET_DEVICE_ATTRIBUTES
IOCTL_HID_GET_REPORT_DESCRIPTOR
IOCTL_HID_READ_REPORT

Other IRPs may be handled by HID class driver 112, and the scope of the invention is not limited in this respect.

IOCTL_HID_GET_DEVICE_DESCRIPTOR may be called to get a device descriptor for HID Class driver 112 as defined by the HID_DESCRIPTOR structure. This structure may declare the HIDFP device to the system and indicates the number and type of descriptors supported by HIDFP minidriver 114.

IOCTL_HID_GET_DEVICE_ATTRIBUTES may be called to get the device attributes of the device of HID Class driver 112 as defined by the HID_DEVICE_ATTRIBUTES structure. This structure may get filled in with the vendor, product, and version number of the device, for example. For HIDFP minidriver 114, one or more of these values may be arbitrarily defined as there may not be a corresponding Universal Serial Bus (USB) device that would otherwise provide such information. The values assigned may include:
VendorID=0×8086
ProductID=0×CC0E
VersionNumber=1
   Other values may be assigned, and the scope of the invention is not limited in this respect.

IOCTL_HID_GET_REPORT_DESCRIPTOR may be called to retrieve the report descriptor for the driver. The report descriptor may declare what types of reports HIDFP minidriver 114 may generate.

IOCTL_HID_READ_REPORT may be called every polling cycle to give the driver an opportunity to report data. HID class driver 112 may perform the polling. The data may be reported via a report that is defined by the report descriptor. The handler for the read report IOCTL may cause state machine 500 to be refreshed, and then create a report based on state machine 500 in the event the data is updated.

HID Class driver 112 may poll the driver periodically by sending an appropriate IOCTL request. HIDFP minidriver 114 may indicate at registration time that it wishes to be polled. HID class driver 112 may determine the polling interval, which may be based on a value set at the top-level collection, for example Consumer Control devices. HID Class driver 112 may poll the device by issuing a IRP_MJ_INTERNAL_DEVICE_CONTROL IOCTL with a code of IOCTL_HID_READ_REPORT. When HIDFP minidriver 114 receives this IOCTL, it may perform one or more of the following actions:
Acquire spin lock;
Get current state machine values;
Check to see if the data retrieved is new data. If so, signal event to update state machine data for next time;
Release spin lock;
If last report was an action, generate an empty report;
If the data obtained was new data, determine type of report to generate, based on state machine; or
Default to return no data

When making an initial transition from a central nothing state to any other state, a button down report may be generated for the state to which a transition was made. Once in a button down state, successive button down reports may be generated after a predetermined number of elapsed polling intervals. The number of elapsed polling intervals may start initially at 100 and may be decremented each polling cycle. When the number reaches 0, another button down report may be generated, and the number of elapsed polling intervals may be set to 5. This process may repeat until the button down state is exited. At this point, the number of elapsed polling intervals may be reset to 100. Such a mechanism may simulate a press and hold actuation of a button. The initial button actuation performs the action once, followed by a short delay, and then actuation may occur repeatedly at a more rapid pace. For example, such a behavior may be implemented for the volume up and down control buttons 414, although the scope of the invention is not limited in this respect. For channel up and down tuning buttons 412, as single press and release of a button may translate into one channel up or down operation. Continually holding the button may not cause channels to continue changing, although the scope of the invention is not limited in this respect. Action reports of volume up or down or channel up or down may cause the next poll to generate an empty report message regardless of the changes made in state machine 500. Such an arrangement may ensure that such action may translate into at least one event of the respective type to occur, and to prevent inadvertent translation into two or more button presses when not so intended, although the scope of the invention is not limited in this respect.

Update of the data of state machine 500 may occur in a separate thread. This thread may be signaled when new data was just retrieved by the main driver execution thread and another refresh is called for. This thread may terminate itself when it detects the bKillThread parameter in the device extension to be set to TRUE and may signal to the main execution thread that the thread has been terminated. One or more of the following actions may be performed to update the values of state machine 500:
Wait on event to be signaled;
Execute ACPI control method to get current data from GPIO registers;
Execute ACPI control method to clear GPIO registers;
Acquire spin lock;
Update state machine data based on fresh data;
Update Boolean flag to indicate data is fresh; or
Release spin lock
   Other actions may be performed, and the scope of the invention is not limited in this respect.

When updating state machine 500, one or more of the following rules may be in effect:
The state of the pins of GPIO circuit 120 may be reset after each polling interval;
One action may occur at a time, for example, a volume up event may not be reported simultaneously with a channel up event; or
Button priorities may include: Held button; Volume down; Volume up; Channel down; and Channel up, although the scope of the invention is not limited in this respect.

The HID Device Attributes data structure may be based on the HID_DEVICE_ATTRIBUTES structure found in the Driver Development Kit (DDK) such as available from Microsoft Corporation of Redmond, Washington, although the scope of the invention is not limited in this respect. The HID Device Descriptor structure may be based on the HID_DESCRIPTOR structure found in the DDK. The HID Report Descriptor may define the number and type of reports a device supports. The report descriptor for the HIDFP minidriver 114 may be as follows:

| | | |
|---|---|---|
| Usage Page (Consumer Devices) | 0x05 | 0x0C |
| Usage (Consumer Control) | 0x09 | 0x01 |
| Collection (Application) | 0xA1 | 0x01 |
| Logical Minimum (0) | 0x15 | 0x00 |
| Logical Maximum (1) | 0x25 | 0x01 |
| Usage (Volume Increment) | 0x09 | 0xE9 |
| Usage (Volume Decrement) | 0x09 | 0xEA |
| Usage (Channel Increment) | 0x09 | 0x9C |
| Usage (Channel Decrement) | 0x09 | 0x9D |
| Report Size (1) | 0x75 | 0x01 |
| Report Count (4) | 0x95 | 0x04 |
| Input (Data, Variable, Absolute) | 0x81 | 0x02 |
| Report Count (4) | 0x95 | 0x04 |
| Input (Constant, Variable, Absolute) | 0x81 | 0x03 |
| End Collection | 0xC0 | |

Other report descriptors may be provided, and the scope of the invention is not limited in this respect.

The lines of the report descriptor may be translated into a one or two byte code. This stream of bytes may be passed as the report descriptor for HIDFP minidriver 114. The report that this descriptor generates can be interpreted as follows: The present device is a consumer control device that supports volume up, volume down, channel up, and channel down. The value used to represent each of these conditions is 0 or 1. Each condition can be represented using one bit and there are four of them. There is a padding of four bits to make the final report size, one byte.

The reports generated by the HIDFP minidriver 114 may indicate to respective clients an action to be performed. The report descriptor may indicate what types of reports to expect and how they are formatted. Based on the Report Descriptor in the previous section, the following bit combinations may indicate the corresponding action to occur:
00000001—Increase the volume;
00000010—Decrease the volume
00000100—Increase the channel
00001000—Decrease the channel
00000000—Empty report
   Other bit combinations and corresponding actions may be provided, and the scope of the invention is not limited in this respect.

At polling intervals, a report that fits one of these criteria may be sent, or otherwise no data may be returned and an invalid status may be returned. In the event of another type of report other than those shown may have no meaning and as a result may cause no event to occur. Once the report is generated and passed back up the device stack, client applications may interpret the report and cause the action to be made, although the scope of the invention is not limited in this respect.

The device extension may be utilized to store device specific information and may be defined by the developer of the driver as follows:
enum eFrontPanelState PreviousState—may contain the previous value of state machine 500;
enum eFrontPanelState CurrentState—may contain the current value of state machine 500;
USHORT Counter—may be utilized to support press and hold behavior by tracking the number of polling cycles that have occurred;
KSPIN_LOCK slUpdateInProgress—this spin lock may be acquired when updates or reads are being done to the PreviousState and CurrentState variables;
BOOL bKillThread—may be set to TRUE when it is time to kill the thread performing state machine updates, and the event eventUpdateData may be signaled to ensure the thread is killed;
HANDLE hPollingThread—the handle of the thread performing updates;
KEVENT eventUpdateData—may be signaled when a request is being made to update the data of state machine 500;
KEVENT eventThreadTerminated—may be signaled when the worker thread has broken out of its while loop and is about ready to terminate itself;
BOOL bDataUpdated—may indicate when data is fresh; if TRUE, data is fresh, Otherwise data is stale and may not be acted upon;
BOOL bWasLastReportAction—may be set after an action report is sent, and may ensure that action reports are followed in the next poll by an empty report
   Other device extensions and information may be provided, and the scope of the invention is not limited in this respect.

The HIDFP minidriver 114 may be registered as a driver requiring polling, as in one embodiment of the invention no underlying hardware support to perform this action may exist. To support polling, HID class driver 112 periodically may request data by generating a IRP_MJ_INTERNAL_DEVICE_CONTROL request specifying the IOCTL, IOCTL_READ_REPORT. This call is made to the driver at IRQL_DISPATCH level, which may be too high to make calls to ACPI control methods. To address such an issue, a separate thread may be created that runs at IRQL_PASSIVE level. Since control methods may be called at this IRQL level, the main execution thread of the driver signals to the other thread via an event to perform an update. Polling may occur sufficiently frequently enough to result in no perceivable difference to the user. The polling frequency may be based on the type of device, for example Consumer Control, which in one embodiment of the invention likely may not be changed, although the scope of the invention is not limited in this respect.

In one embodiment of the invention, HIDFP minidriver 114 may call two separate control methods, which may be called one right after the other. As there is some overhead to calling control methods, in an alternative embodiment, these two control methods may be consolidated into one, and the code may be modified to make a single call, although the scope of the invention is not limited in this respect. In another embodiment of the invention, to simplify the processing of data, ASL code may be added to generate OS events in the event the signals of GPIO circuit 120 are changed. In such an embodiment, the driver may be modified to stop using polling, listen for these events, and generate reports when these events are received. Such an arrangement may entail a BIOS change to implement the ASL events, registering for notification events from the ACPI driver during initialization, and processing these events, although the scope of the invention is not limited in this respect.

Although the invention has been described with a certain degree of particularity, it should be recognized that elements thereof may be altered by persons skilled in the art without departing from the spirit and scope of the invention. It is believed that the control board system of the present invention and many of its attendant advantages may be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

1. An apparatus, comprising:
a control panel for a computing platform, said control panel having at least one control button to control an operation of a computing platform; and
a general purpose input/output circuit to couple to the control button of said control panel;
wherein actuation of the at least one control button causes said general purpose input/output circuit to execute the operation via a human interface device driver.

2. An apparatus as claimed in claim 1, wherein the operation is able to be executed without utilizing a Universal Serial Bus controller.

3. An apparatus as claimed in claim 1, wherein the control button includes at least one of a brightness control button, a channel control button, a volume control button, or a power control button.

4. An apparatus as claimed in claim 1, wherein actuation of the at least one control button causes a human interface device report to be generated within the computing platform.

5. An apparatus as claimed in claim 1, wherein the computing platform includes a television tuner to receive a television signal, the control button of said control panel to control a function of the television tuner.

6. A method, comprising:
monitoring a status of at least one pin of a general purpose input/output circuit to detect an actuation of the at least one pin;
in the event an actuation of the least one pin of the general purpose input/output circuit is detected, generating a human interface device report; and
in response to the report, executing a control function.

7. A method as claimed in claim 6, wherein said monitoring includes calling an advanced configuration power interface control to obtain a status of the at least one pin of the general purpose input/output circuit.

8. A method as claimed in claim 7, further comprising, in the event an actuation is not detected, waiting for a predetermined time, and then again executing said calling.

9. A method as claimed in claim 6, wherein said executing is performed by an operating system without utilizing a controller.

10. A method as claimed in claim 6, wherein said executing includes controlling at least one of a brightness control function, a channel control function, a volume control function, or a power control function.

11. An article comprising a storage medium having stored thereon instructions that, when executed by a computing platform, result in control of an operation of the computing platform by:
monitoring a status of at least one pin of a general purpose input/output circuit to detect an actuation of the at least one pin;
in the event an actuation of the at least one pin of the general purpose input/output circuit is detected, generating a human interface device report; and
in response to the report, executing a control function.

12. An article as claimed in claim 11, wherein the instructions, when executed, further result in control of an operation of the computing platform by calling an advanced configuration power interface control to obtain a status of the at least one pin of the general purpose input/output circuit.

13. An article as claimed in claim 12, wherein the instructions, when executed, further result in control of an operation of the computing platform by, in the event an actuation is not detected, waiting for a predetermined time, and executing said calling.

14. An article as claimed in claim 11, wherein said executing is performed by an operating system without utilizing a controller.

15. An article as claimed in claim 11, wherein said executing includes controlling at least one of a brightness control function, a channel control function, a volume control function, or a power control function.

16. An apparatus, comprising:
a receiver to receive a multimedia signal broadcast from remote source, and a decoder to decode the multimedia signal;
a control panel for a computing platform, said control panel having at least one control button to control an operation of a computing platform; and
a general purpose input/output circuit to couple to the control button of said control panel;
wherein actuation of the at least one control button causes said general purpose input/output circuit to execute the operation via a human interface device driver.

17. An apparatus as claimed in claim 16, wherein the operation is able to be executed without utilizing a Universal Serial Bus controller.

18. An apparatus as claimed in claim 16, wherein the control button includes at least one of a brightness control button, a channel control button, a volume control button, or a power control button.

19. An apparatus as claimed in claim 16, wherein actuation of the at least one control button causes a human interface device report to be generated within the computing platform.

20. An apparatus as claimed in claim 16, further comprising a display to display the multimedia signal.

21. An apparatus as claimed in claim 16, wherein the control button includes at least one of a brightness control button, a channel control button, a volume control button, or a power control button.
